(19) United States
(12) Patent Application Publication
(10) Pub. No.: US 2002/0167554 A1
(43) Pub. Date: Nov. 14, 2002

(54) Methods and systems of using data fields to print dynamic data

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/861,985

(22) Filed: May 10, 2001

(51) Int. Cl. B41J 29/38

(52) U.S. Cl. 347/5

(57) ABSTRACT

Methods and systems of variable data printing are described. In one embodiment, methods and systems create a print job and incorporate into the print job one or more data fields. The data fields are configured to instruct a printing device to retrieve dynamic data from a dynamic data source. The dynamic data is then incorporated into a printed document.

### TECHNICAL FIELD

The present invention pertains to printing and, in particular, to printing data.

### BACKGROUND

Application programs that are configured for use with printers, such as laser printers and the like, typically generate a specification of an item that is to be printed in what is known as a page description language or PDL. A PDL is simply a specification that includes instructions that a printer understands and uses to print a page. Exemplary PDLs include PostScript and PCL. Many times, a print job that is generated by an application program will simply contain static data. Consider, for example, a simple document that is generated by a word processing program. Perhaps the document is a report of some type. Consider that in preparing the report, a user has physically entered all of the data into the document that is necessary for the report. In this instance, the application program would simply process the user's word processing document to provide the appropriate PDL for a printer to print the document.

Consider now a situation where a user desires to enter different data into the same document over and over again. For example, if a user generates a letter and desires to send the letter to hundreds of different people, they have a couple of different choices to accomplish this task. First, the user might himself physically enter each individual address into a separate letter, print the letter, and move on to the next address. This is not at all an efficient approach as it requires the user to perform a task for each of the individual letters that he desires to send. If there are hundreds of letters, this might take all day.

Second, the user can employ what is known as a variable data field in their letter or document.

Consider, for example, FIG. 1 which shows a system 100 which includes a computer 102, a printer 104, a hard disk 106 comprising part of printer 104, and a print job 108 in the form of a letter. The print job 108 comprises PDL and has been created on computer 102. A variable data field 110 is incorporated into the PDL and indicates to the printer that the printer has to do some additional work to prepare and print the letters. Specifically, printer 104 can contain a list of addresses on its hard disk 106. As the printer prints each letter, it consults the list, obtains a new address, inserts the address into the variable data field and prints a letter. The printer then moves on to the next letter and address. An example of variable data printing is described in U.S. Pat. No. 5,729,655.

This type of variable data field printing typically prints data that is static in nature, i.e. the data does not change frequently (from minute-to-minute). Specifically, data stores that provide the data that is used in variable data printing typically contain large amounts of static or stagnant data. While this approach is a good approach for tasks such as address printing, its leaves much to be desired for users who desire a more robust, flexible approach to printing.

Accordingly, this invention arose out of concerns associated with providing robust, flexible printing solutions that utilize variable data field printing.

### SUMMARY

Methods and systems of printing data are described. In one embodiment, methods and systems create a print job and incorporate into the print job one or more data fields. The data fields are configured to instruct a printing device to retrieve dynamic data (i.e. frequently-changing data) from a dynamic data source.

In another embodiment, methods and systems process a print job by receiving, with a printing device, a print job that includes one or more data fields. The data fields are configured to instruct the printing device to retrieve dynamic data from a dynamic data source. The data field(s) are processed to retrieve dynamic data from the dynamic data source, and a document is printed to contain the retrieved dynamic data.

In a further embodiment, methods and systems render a document by providing a data field and processing the data field to ascertain a location from which dynamic data can be obtained. Dynamic data is obtained from the ascertained location and a document is rendered to contain the obtained dynamic data.

### BRIEF DESCRIPTION OF THE DRAWINGS

FIG. 1 is a diagram that illustrates a printing system in accordance with the prior art.

FIG. 2 is a block diagram of an exemplary printer.

FIG. 3 is a block diagram of an exemplary computer.

FIG. 4 is a diagram that illustrates a printing system in accordance with one embodiment.

FIG. 5 is a flow diagram that describes steps in a method in accordance with one embodiment.

FIG. 6 is a diagram of an exemplary implementation in accordance with one embodiment.

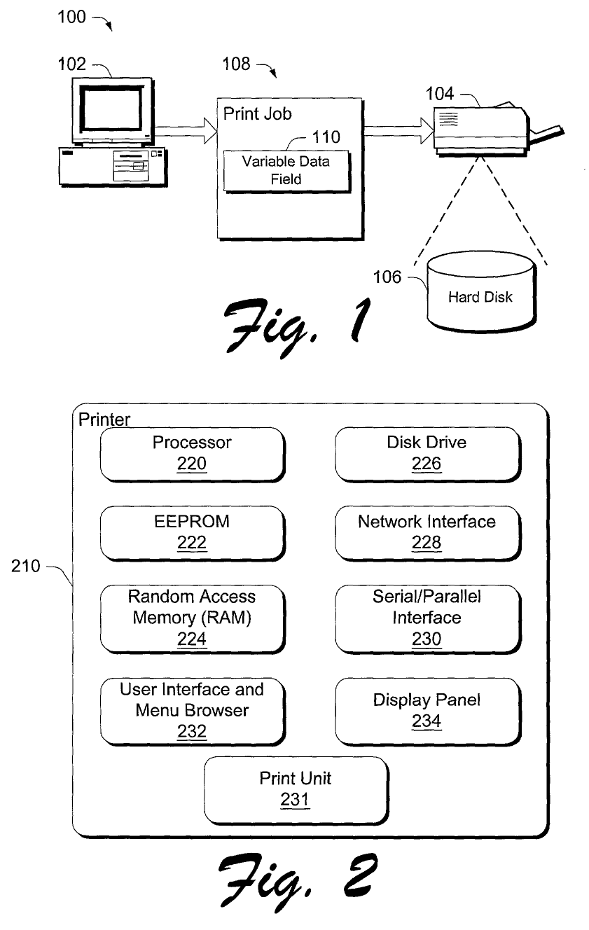

### DETAILED DESCRIPTION

### Overview

Robust and flexible printing solutions are described that enable data fields to be utilized to print dynamic data. Accordingly, documents can be rendered to contain data that changes frequently.

### Exemplary Printing Device

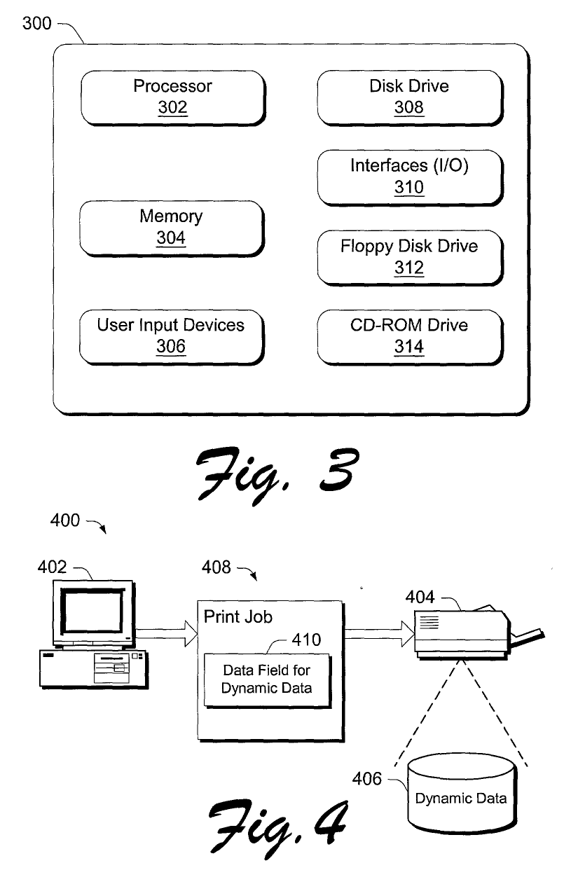

FIG. 2 is a block diagram showing exemplary components of a printing device in the form of a printer 210 that can be used in accordance with the described embodiments. While FIG. 2 illustrates a specific type of printing device, it should be appreciated that other printing devices such as facsimile machines, copiers, and the like can be utilized without departing from the spirit and scope of the claimed subject matter.

Printer 210 includes one or more processors 220 and at least one computer-readable media. In this example, the computer readable media can include, without limitation, an electrically erasable programmable read-only memory (EEPROM) 222 and a random access memory (RAM) 224. Processor(s) 220 processes various instructions necessary to operate the printer 210 and communicate with other devices. EEPROM 222 and RAM 224 store various information such as configuration information, fonts, templates, data being printed, and menu structure information. Although not shown in FIG. 2, a particular printer may also contain a ROM (non-erasable) in place of or in addition to EEPROM 222. Furthermore, a printer may alternatively contain a flash memory device in place of or in addition to EEPROM 222.

Printer 210 can also include a disk drive 226, a network interface 228, and a serial/parallel interface 230. Disk drive 226 provides additional storage for data being printed or other information used by the printer 210. Although both RAM 224 and disk drive 226 are illustrated in FIG. 2, a particular printer may contain either RAM 224 or disk drive 218, depending on the storage needs of the printer. For example, an inexpensive printer may contain a small amount of RAM 224 and no disk drive 218, thereby reducing the manufacturing cost of the printer. Network interface 228 provides a connection between printer 210 and a data communication network. Network interface 228 allows devices coupled to a common data communication network to send print jobs, menu data, and other information to printer 210 via the network. Similarly, serial/parallel interface 230 provides a data communication path directly between printer 210 and another device, such as a workstation, server, or other computing device. Although the printer 210 shown in FIG. 2 has two interfaces (network interface 228 and serial/parallel interface 230), a particular printer may only contain one interface.

Printer 210 also includes a print unit 231 that includes mechanisms that are arranged to selectively apply ink (e.g., liquid ink, toner, etc.) to a print media (e.g., paper, plastic, fabric, etc.) in accordance with print data within a print job. Thus, for example, print unit 231 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner. Print unit 231 can also be configured to support duplex printing, for example, by selectively flipping or turning the print media as required to print on both sides. The print unit 231 can also comprise an ink jet print unit that utilizes principles of ink jet printing. Those skilled in the art will recognize that there are many different types of print units available, and that for the purposes of the present discussion, print unit 231 can include any of these various types.

Printer 210 can also contain a user interface/menu browser 232 and a display panel 234. User interface/menu browser 232 allows the user of the printer to navigate the printer's menu structure. User interface 232 may be a series of buttons, switches or other indicators that are manipulated by the user of the printer. Display panel 234 is a graphical display that provides information regarding the status of the printer and the current options available through the menu structure.

The illustrated printer can, and typically does include software that provides a runtime environment in which software applications or applets can run or execute. One exemplary runtime environment is an Embedded Virtual Machine (EVM). Other runtime environments can, of course, be used. The runtime environment can facilitate the extensibility of the printer by allowing various interfaces to be defined that, in turn, allow applications or applets to interact with the printer in more robust manners. It will be appreciated that the inventive techniques and methods described herein include all forms of computer-readable media when such media contains instructions which, when executed by a processor or computer, implement the techniques and methods.

### Exemplary Host Computer

FIG. 3 is a block diagram showing exemplary components of a computer workstation 300. Workstation 300 includes one or more processors 302, a memory 304 (such as ROM and RAM), user input devices 306, a disk drive 308, interfaces 310 for inputting and outputting data, a floppy disk drive 312, and a CD-ROM drive 314. Processor 302 performs various instructions to control the operation of workstation 300. Memory 304, disk drive 308, and floppy disk drive 312, and CD-ROM drive 314 provide data storage mechanisms. User input devices 306 include a keyboard, mouse, pointing device, or other mechanism for inputting information to workstation 300. Interfaces 310 provide a mechanism for workstation 300 to communicate with other devices.

### Exemplary Embodiment

In accordance with the described embodiment, data fields are used to instruct a printing device, such as a printer, to retrieve and insert into a printed document, data that is dynamic or “real time” in nature. One example of such a data field is a so-called variable data field. Data that is dynamic in nature or “dynamic data” is different from static data in that it changes frequently over time. As an example, static data can comprise such things as address lists that might be stored unchanged in a central database for several months. Dynamic or real time data, on the other hand, can comprise things such as data associated with a current time, location, temperature, weather and stock quotes to name just a few. Hence, the characteristics of dynamic data that differentiate it from static data is that it typically changes frequently, for example, from minute-to-minute or from second-to-second.

In the described embodiment, print job-driven dynamic data acquisition systems and methods are provided. For example, consider FIG. 4. There, a system 400 includes a computer 402, a printer 404, a source of dynamic data 406, and a print job 408 that has been formulated by computer 402. The print job can include one or more data fields 410 for accommodating dynamic data. In the present example, the data field 410 comprises a variable data field that comprises part of the page description language that makes up the print job. The variable data field includes instructions that instruct the printer to retrieve dynamic data from source 406 and insert the dynamic data into a printed document.

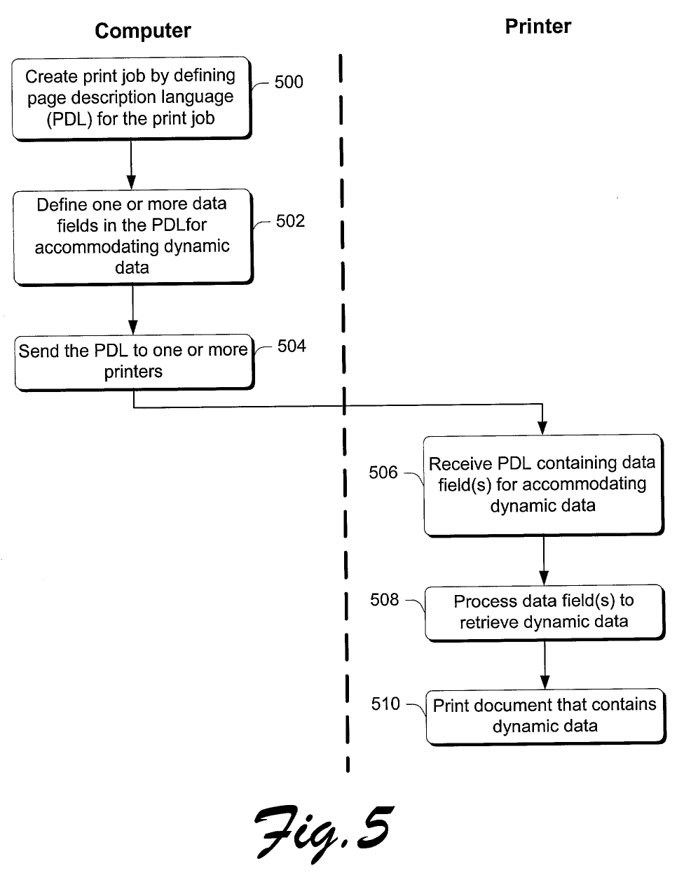

FIG. 5 is a flow diagram that describes steps in a method in accordance with one embodiment. The method can be implemented in any suitable hardware, software, firmware or combination thereof. In the illustrated and described embodiment, the method is implemented in software.

FIG. 5 is divided into two sections. One section describes steps that are carried out by a computer, such as a client computer that a user might use to formulate a print job. The other section describes steps that are carried out by a printing device which, in this example, comprises a printer.

Step 500 creates a print job which, in this example, defines page description language (PDL) for the print job. This step can be performed in any suitable way using any suitable page description language. Exemplary page description languages include, without limitation, PostScript and PCL. Step 502 defines one or more data fields in the PDL for accommodating dynamic data. In the illustrated and described example, the data fields comprise variable data fields. This step can be performed contemporaneously with step 500. The data field or fields are incorporated in the PDL and contain instructions that can be used by a printer to fetch or otherwise retrieve the dynamic data. Step 504 then sends the PDL including the data field(s) to one or more printers. This step can be performed using any suitable communication medium that is established between the computer and the printer.

Step 506 receives the PDL that includes the data field(s). Step 508 processes the data field(s) to retrieve dynamic data from a source of dynamic data. It will be appreciated that sources of dynamic data can include any suitable sources that can be accessed in any suitable way. For example, the printer itself may comprise the source of the dynamic data by, for example, maintaining a data store that is dynamic in nature. Alternately, the dynamic data source can be a network-accessible data location. Regardless of the location of the dynamic data source, step 508 retrieves the dynamic data and step 5 10 prints a document that contains the dynamic data.

The above-described process illustrates but one example of a method that provides one or more data fields that can be processed to ascertain a location or source from which dynamic data can be obtained. Dynamic data can then be obtained from the ascertained location or source, and a document can be rendered to contain the dynamic data. Document rendering can take place in any suitable way, e.g. laser rendering, ink jet rendering, or any other suitable rendering device or process where it is desirable to incorporate dynamic data into a final rendered document.

### Exemplary Implementation

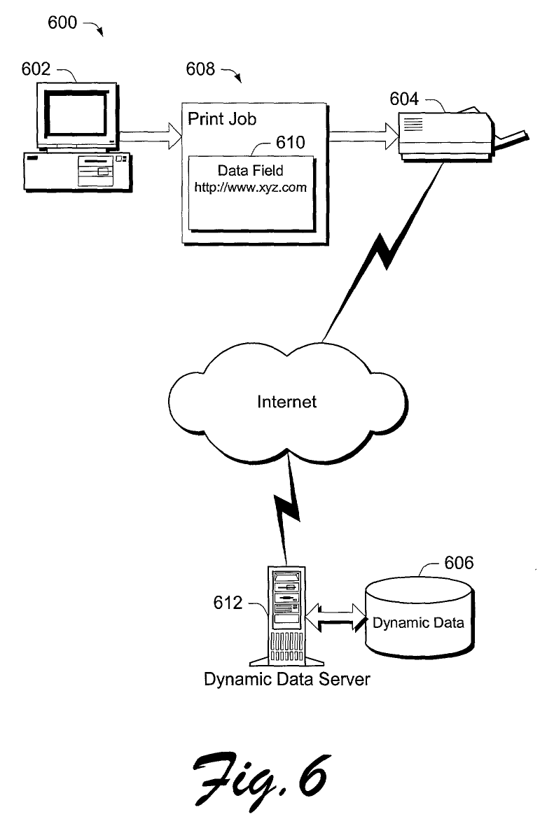

FIG. 6 shows an exemplary system 600 that is configured in accordance with one embodiment. System 600 includes a computer 602, a printer 604, a print job 608 having a data field 610. In this example, the data field includes a URL 610 that defines a network-accessible data location for retrieving dynamic data. A network-accessible data location is accessible via the Internet and includes a dynamic data server 612 and a data store 606 for dynamic data. In this example, the data field includes the URL “. . . www.xyz.com” which is a link that can be followed by the printer to dynamic data server 612. Instructions included with the print job 608 instruct the printer not only as to the location of the dynamic data, but the specific dynamic data to retrieve as well. So, for example, when the printer 604 receives print job 608, it processes the data field to retrieve the URL. It then uses the URL to access the dynamic data server 612 via the Internet. The printer can do this using known conventional communication protocols.

Once the dynamic data server has been accessed by the printer. The printer can then use the instructions that are included in the PDL to instruct the data server 612 on the specific information to retrieve from data store 606. Once the data server 612 retrieves the dynamic data, it bundles the data up and sends it to the printer 604 via the Internet. The printer can then incorporate the dynamic data into a document that it prints.

Consider, for example, a situation where an individual desires to print a mid-day letter that contains a list of the current up-to-the-minute stock quotes for 50 or 60 stocks. The individual prepares their letter in the usual way using an appropriate word processing program. The program enables the user to define an area where a data field for dynamic data is to be inserted. The user can then specify the type and location of the dynamic data. When the user's word processing program formulates the letter into its PDL and forwards the PDL to the printer, the printer processes the PDL and ascertains that this particular document needs dynamic data. It uses the information in the data field to navigate to a web location that contains real time stock quotes for the 50 or 60 stocks that have been specified by the user. The real time stock quotes are obtained by the printer and are inserted into the appropriate location in the user's letter when the letter is printed.

### Conclusion

The techniques and systems described above provide for the use of data fields to retrieve and insert dynamic data into printed documents. Particular utility is derived in the context of printing devices such as printers that can be configured to use the data fields to access the dynamic data from locations. that are remote from the printing devices. Such locations can include, without limitation, Internet-accessible locations. Accordingly, printing solutions are provided that are robust and flexible insofar as being able to incorporate continuously-changing, dynamic data into a printed document.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the invention.

1. A method of creating a print job comprising:
creating a print job; and
incorporating one or more data fields in the print job, the data fields being configured to instruct a printing device to retrieve dynamic data from a dynamic data source.

2. The method of claim 1, wherein said incorporating comprises configuring the data field(s) to instruct one or more of a laser printer or an ink jet printer.

3. The method of claim 2, wherein said configuring comprises configuring the data field(s) with at least one URL.

4. The method of claim 1, wherein said incorporating comprises configuring the data field(s) to instruct the printing device to retrieve dynamic data from a network-accessible location.

5. The method of claim 1, wherein said incorporating comprises configuring the data field(s) to instruct the printing device to retrieve dynamic data from an Internet-accessible location.

6. The method of claim 1, wherein said incorporating comprises configuring the data field(s) to instruct the printing device to retrieve dynamic data from a location remote from the printing device.

7. The method of claim 1, wherein said creating comprises defining page description language (PDL) for the print job.

8. A method of processing a print job comprising:
receiving, with a printing device, a print job that includes one or more data fields, the data fields being configured to instruct a printing device to retrieve dynamic data from a dynamic data source;
processing the data field(s) to retrieve dynamic data from the dynamic data source; and
printing a document that contains the retrieved dynamic data.

9. The method of claim 8, wherein said receiving comprises receiving a print job that is defined in a page description language (PDL).

10. The method of claim 8, wherein said receiving comprises receiving the print job with one or more of a laser or ink jet printer.

11. The method of claim 8, wherein said processing comprises retrieving the dynamic data from a dynamic data source that is external to the printing device.

12. The method of claim 8, wherein said processing comprises retrieving the dynamic data from a network-accessible dynamic data source.

13. The method of claim 8, wherein said processing comprises retrieving the dynamic data from an Intemetoaccessible dynamic data source.

14. A method of rendering a document comprising:
providing a data field;
processing the data field to ascertain a location from which dynamic data can be obtained;
obtaining dynamic data from the ascertained location; and
rendering a document that contains the obtained dynamic data.

15. The method of claim 14, wherein said rendering comprises printing the document on a printer.

16. The method of claim 14, wherein said rendering comprises printing the document on a laser printer.

17. The method of claim 14, wherein said rendering comprises printing the document on a ink jet printer.

18. One or more computer-readable media having stored thereon a plurality of instructions that, when executed by one or more processors of a client computer, causes the one or more processors to::
create a print job; and
incorporate one or more data fields in the print job, the data fields being configured to instruct a printing device to retrieve dynamic data from a dynamic data source.

19. The one or more computer-readable media of claim 18, wherein the instructions instruct a printing device to retrieve the dynamic data from a network-accessible location.

20. The one or more computer-readable media of claim 18, wherein the instructions instruct a printing device to retrieve the dynamic data from an Internet-accessible location.

21. One or more computer-readable media having stored thereon a plurality of instructions that, when executed by one or more processors of a printing device, causes the one or more processors to:
receive a print job that includes one or more data fields, the data fields being configured to instruct the printing device to retrieve dynamic data from a dynamic data source;
process the data field(s) to retrieve dynamic data from the dynamic data source; and
print a document that contains the retrieved dynamic data.

22. The one or more readable media of claim 21, wherein the instructions cause the one or more processors to retrieve the dynamic data from a dynamic data source that is external to the printing device.

23. The one or more readable media of claim 21, wherein the instructions cause the one or more processors to retrieve the dynamic data from an Internet-accessible dynamic data source.

24. One or more computer-readable media having stored thereon a plurality of instructions that, when executed by one or more processors of a rendering device, causes the one or more processors to:
provide a data field;
process the data field to ascertain a location from which dynamic data can be obtained;
obtain dynamic data from the ascertained location; and
render a document that contains the obtained dynamic data.

25. A computing device comprising:
at least one processor;
one or more computer-readable media;
computer-readable instructions resident on the computer-readable media and executable by the one processor to:
create a print job; and
incorporate one or more data fields in the print job, the data fields being configured to instruct a printing device to retrieve dynamic data from a dynamic data source.

26. A printing device comprising:
at least one processor;
one or more readable media;
instructions resident on the readable media and executable by the one processor to:
receive a print job that includes one or more data fields, the data fields being configured to instruct the printing device to retrieve dynamic data from a dynamic data source;
process the data field(s) to retrieve dynamic data from the dynamic data source; and
print a document that contains the retrieved dynamic data.

27. The printing of claim 26, wherein the instructions cause the processor to retrieve the dynamic data from a dynamic data source that is external to the printing device.

28. The printing device of claim 26, wherein the instructions cause the processor to retrieve the dynamic data from an Internet-accessible dynamic data source.
